(19) United States
(12) Patent Application Publication
(10) Pub. No.: US 2024/0119375 A1
(43) Pub. Date: Apr. 11, 2024

(54) VISIT SCHEDULE CREATION METHOD

(71) Applicant: NEC Corporation, Minato-ku, Tokyo (JP)

(72) Inventor: Kosuke NISHIHARA, Tokyo (JP)

(73) Assignee: NEC Corporation, Minato-ku, Tokyo (JP)

(21) Appl. No.: 18/285,727

(22) PCT Filed: Apr. 16, 2021
(86) PCT No.: PCT/JP2021/015733

§ 371 Date: Oct. 5, 2023

(51) Int. Cl. G06Q 10/0631

(52) U.S. Cl. CPC G06Q 10/063114; G06Q 10/063116

(57) ABSTRACT

A visit schedule creation device 100 of the present invention includes an assignment unit 121 that, on the basis of location information of a visitor and a visited person, creates a visit schedule in which the visited person, to be visited by the visitor, is assigned to the visitor; a calculation unit 122 that calculates priority representing a level of priority of the visited person assigned to the visitor, on the basis of the location information; and a reassignment unit 123 that creates the visit schedule in which assignment of the visited person to the visitor is changed, on the basis of the priority.

### TECHNICAL FIELD

The present invention relates to a visit schedule creation method, a visit schedule creation device, and a program.

### BACKGROUND ART

Recently, along with an increase in elderly population, the number of elderly persons who need care is increasing. Accordingly, need of home-visit care is also increasing, and a visit to home by a service provider is carried out. Therefore, a service provider needs to create a visit schedule in order to visit home efficiently. For example, in Patent Literature 1, a visit schedule is created in consideration of the home location of a visited person.

### CITATION LIST

### Patent Literature

Patent Literature 1: JP 2017-126136 A

### SUMMARY OF INVENTION

### Technical Problem

However, recently, due to shortage of carers and nurses serving as visitors in addition to an increase in the number of persons to be cared who are visited persons, a visit schedule is complicated. As a result, there is also a problem of an increase in the calculation cost for creating a visit schedule.

In view of the above, an object of the present invention is to provide a visit schedule creation method capable of solving the above-described problem, that is, a problem of an increase in the calculation cost for creating a visit schedule.

### Solution to Problem

A visit schedule creation method, according to one aspect of the present invention, is configured to include,
on the basis of location information of a visitor and a visited person, creating a visit schedule in which the visited person, to be visited by the visitor, is assigned to the visitor;
calculating priority representing a level of priority of the visited person assigned to the visitor, on the basis of the location information; and
creating the visit schedule in which assignment of the visited person to the visitor is changed, on the basis of the priority.

Further, a visit schedule creation device, according to one aspect of the present invention, is configured to include
an assignment unit that, on the basis of location information of a visitor and a visited person, creates a visit schedule in which the visited person, to be visited by the visitor, is assigned to the visitor;
a calculation unit that calculates priority representing a level of priority of the visited person assigned to the visitor, on the basis of the location information; and
a reassignment unit that creates the visit schedule in which assignment of the visited person to the visitor is changed, on the basis of the priority.

Further, a program, according to one aspect of the present invention, is configured to cause a computer to execute processing to:
on the basis of location information of a visitor and a visited person, create a visit schedule in which the visited person, to be visited by the visitor, is assigned to the visitor;
calculate priority representing a level of priority of the visited person assigned to the visitor, on the basis of the location information; and
create the visit schedule in which assignment of the visited person to the visitor is changed, on the basis of the priority.

### Advantageous Effects of Invention

Since the present invention is configured as described above, the calculation cost for creating a visit schedule can be suppressed.

### BRIEF DESCRIPTION OF DRAWINGS

FIG. 1 is a block diagram illustrating a configuration of a visit schedule creation device according to a first exemplary embodiment of the present invention.

FIG. 2 illustrates an example of data to be processed by the visit schedule creation device disclosed in FIG. 1.

FIG. 3 illustrates a state of data processing by the visit schedule creation device disclosed in FIG. 1.

FIG. 4 illustrates a state of data processing by the visit schedule creation device disclosed in FIG. 1.

FIG. 5 illustrates a state of data processing by the visit schedule creation device disclosed in FIG. 1.

FIG. 6 illustrates a state of data processing by the visit schedule creation device disclosed in FIG. 1.

FIG. 7 is a flowchart illustrating an operation of the visit schedule creation device disclosed in FIG. 1.

FIG. 8 is a block diagram illustrating a hardware configuration of a visit schedule creation device according to a second exemplary embodiment of the present invention.

FIG. 9 is a block diagram illustrating a configuration of the visit schedule creation device according to the second exemplary embodiment of the present invention.

FIG. 10 is a block diagram illustrating an operation of the visit schedule creation device according to the second exemplary embodiment of the present invention.

### DESCRIPTION OF EMBODIMENTS

### First Exemplary Embodiment

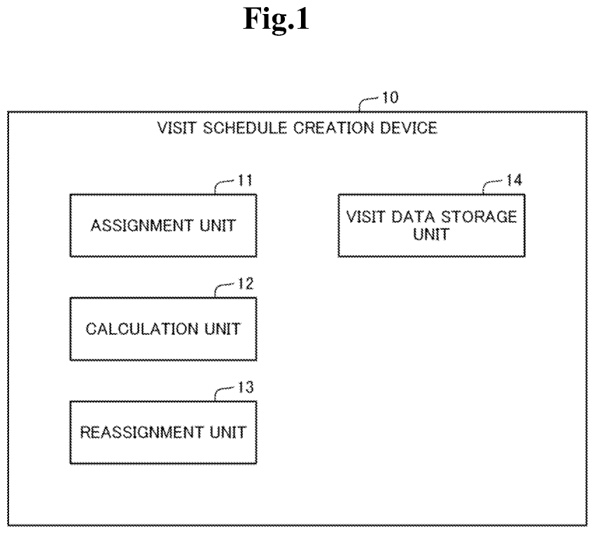

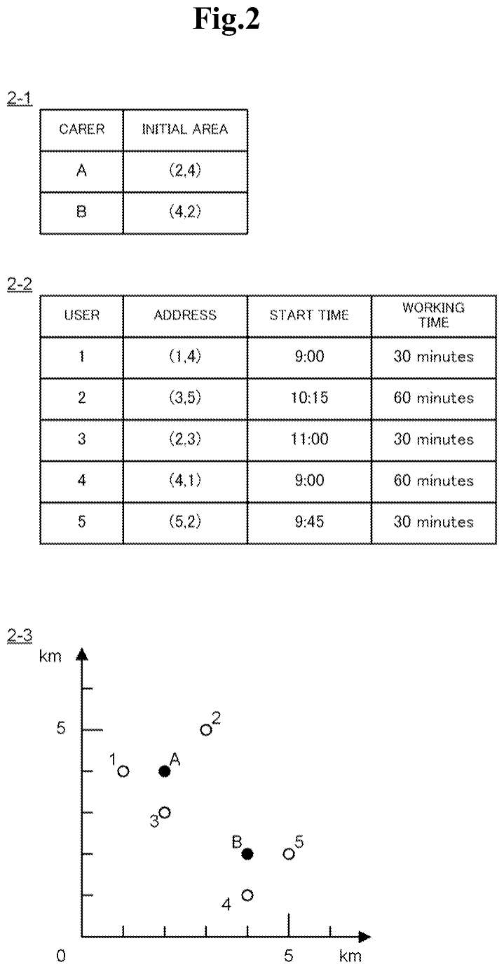

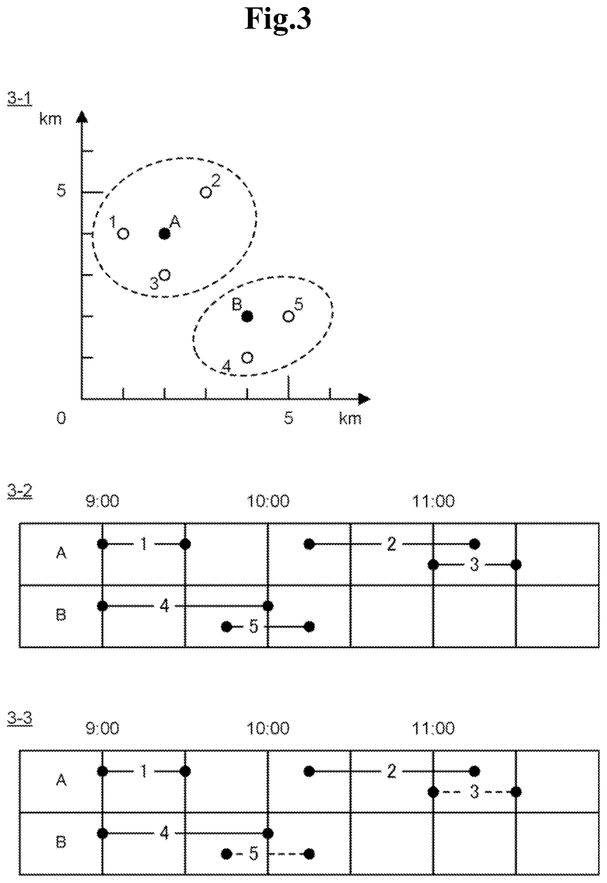

A first exemplary embodiment of the present invention will be described with reference to FIGS. 1 to 7. FIGS. 1 and 2 are diagrams for explaining a configuration of a visit schedule creation device, and FIGS. 3 to 7 are diagrams for explaining the processing operation by the visit schedule creation device.

### [Configuration]

A visit schedule creation device 10 of the present invention is a system for creating a schedule of visiting the care-receiver's home by a carer to provide a home-visit care service by a service provider. In particular, the visit schedule creation device 10 is configured to create a visit schedule to enable each of carers to visit a plurality of care-receivers efficiently. Note that a visit schedule created by the visit schedule creation device 10 of the present invention is not necessarily limited to a schedule of visiting care-receivers by a carer. For example, a visit schedule created by the visit schedule creation device 10 may be any visit schedule such as a schedule of vising patients (visited persons) by a doctor or a nurse (visitor), a schedule of vising persons in charge of equipment in offices (visited persons) by an operator who performs repair and maintenance of office equipment (visitor), or a schedule of visiting persons who are delivery destinations (visited persons) by a home delivery dealer (visitor).

The visit schedule creation device 10 is configured of one or a plurality of information processing devices each having an arithmetic device and a storage device. As illustrated in FIG. 1, the visit schedule creation device 10 includes an assignment unit 11, a calculation unit 12, and a reassignment unit 13. The functions of the assignment unit 11, the calculation unit 12, and the reassignment unit 13 can be realized through execution, by the arithmetic device, of a program for realizing the respective functions stored in the storage device. The visit schedule creation device 10 also includes a visit data storage unit 14. The visit data storage unit 14 is configured of a storage device. Hereinafter, the respective constituent elements will be described in detail.

The visit data storage unit 14 stores therein visit data that is information about a carer who is a visitor and a user, that is, a visited person who utilizes a home-visit care service to receive a visit and care by the carer. Hereinafter, details of the visit data will be described. The contents of visit data are predetermined by the service provider, carers, users, user's families, and the like. The visit data is input and stored in the visit schedule creation device 10 by the operator of the service provider, or input and stored in the visit schedule creation device 10 via a network by the carer, the user, and the user's family.

The visit data includes an initial area (location information) representing the location where a carer starts visiting as carer's data. For example, the initial area of the carer may be a business office to which the carer belongs or the carer's home, but it may be any place. As described below, the initial area may be calculated and set according to the addresses of a plurality of users by the visit schedule creation device 10. In the present embodiment, as shown in FIG. 2 (2-1), the initial area is represented in a two-dimensional coordinate system to simplify the description. As an example, the example of FIG. 2 (2-1) shows the case where the initial area of a carer A is (2, 4) and the initial area of a carer B is (4, 2). When the initial areas of the carers A and B are shown on a map, they are shown as FIG. 2 (2-3).

The visit data includes an address representing a location to be visited by a carer (location information) as user's data. For example, the address of a user may be the user's home or a facility where the user stays, but it may be any place. In the present embodiment, as shown in FIG. 2 (2-2), the address is represented in a two-dimensional coordinate system to simplify the description. As an example, the example of FIG. 2 (2-2) illustrates the case where the address of a user 1 is (1, 4), the address of a user 2 is (3, 5), the address of a user 3 is (2, 3), the address of a user 4 is (4, 1), and the address of a user 5 is (5, 2). When the addresses of the users 1 to 5 are shown on a map, they are shown as FIG. 2 (2-3).

The visit data includes, as user's data, the start time representing a scheduled time that a carer visits a user to start home-visit care (scheduled visit time), and a working time representing a scheduled period of time in which the carer visits the user and stays at the visited place for the care work (scheduled staying time). As an example, the example of FIG. 2 (2-2) shows the case where the start time of the user 1 is 9:00 and the working time is 30 minutes, the start time of the user 2 is 10:15 and the working time is 60 minutes, the start time of the user 3 is 11:00 and the working time is 30 minutes, the start time of the user 4 is 9:00 and the working time is 60 minutes, and the start time of the user 5 is 9:45 and the working time is 30 minutes.

Although not shown, the visit data may include attribute information representing the attributes of the carers and the users, and relevance information representing the relevance between the carers and the users. For example, for a carer, the attribute information is information such as qualification related to nursing and the field of expertise of the carer, and the condition of care of users that the carer can handle. For a user, the attribute information is information such as qualification and the field of expertise capable of handling the care of the user and the condition of care. Further, the relevance information includes, for example, information in which a carer and a user are associated with each other, such as correspondence information between a carer and a user determined to be cared by the carer, correspondence information between a carer and a user cared by the carer in the past, and correspondence information between a carer and a user who desires to be cared by the carer.

The assignment unit 11 first creates a visit schedule in which a carer is assigned with a user that the carer will visit, on the basis of visit data stored in the visit data storage unit 14. Specifically, the assignment unit 11 calculates a distance to the address of each user with respect to the initial area of each carer, and assigns each user to a carer of the shortest distance. That is, in the example of FIG. 2, the users 1 to 5 are assigned to either the carer A or the carer B having the shorter distance. As a result, as illustrated in FIG. 3 (3-1), the users 1, 2, and 3 are assigned to the carer A, and the users 4 and 5 are assigned to the carer B. FIG. 3 (3-2) illustrates a visit schedule in which the start time and the working time for each user are included. In FIG. 3 (3-2), the upper row shows the carer A, the lower row shows the carer B, the horizontal axis shows time, and the working time for each user assigned to each carer is shown by a solid line along the time direction. Note that the assignment unit 11 may assign users by using the initial areas of the carers A and B that are previously included in the visit data. Moreover, the assignment unit 11 may set the initial areas of the carers A and B on the basis of the addresses of the users that are previously included in the visit data, and assign users by using the initial areas. For example, the assignment unit 11 may set the center of the addresses of a plurality of nearby uses as an initial area of a carer.

The calculation unit 12 checks whether or not there is a conflict between users assigned to a carer in the visit schedule created by the assignment unit 11 as described above. For example, the calculation unit 12 determines that there is a conflict when a plurality of users are assigned to the same carer at the same time, that is, in the case where at least part of the periods from the start time until the end of work of a plurality of users assigned to one carer overlap. As an example, in the visit schedule created as shown in FIG. 3 (3-2), with respect to the carer A, it is determined that there is a conflict between the user 2 and the user 3 because the working time for the user 2 and the working time for the user 3 partially overlap with each other at the same time. Moreover, with respect to the carer B, it is determined that there is a conflict between the user 4 and the user 5 because the working time for the user 4 and the working time for the user 5 partially overlap with each other at the same time.

Then, when determining that there is a conflict between users with respect to the same carer, the calculation unit 12 calculates the priority representing the level of visiting priority with respect to each of the conflicted users assigned to the carer. For example, the calculation unit 12 calculates the priority in such a manner that the priority becomes higher as the moving time to visit a user by the carer and the spare time until the carer starts caring for the user become shorter.

Specifically, the calculation unit 12 first calculates a score serving as the source of priority. Here, when the score of a user ‘b’ with respect to a carer ‘a’ is represented as s(a, b), s(a, b) calculates the sum of “moving distance from the location of the carer ‘a’ to the location of the user ‘b”’ and “movable distance from the end time of the home-visit care of the previous user by the carer ‘a’ until the start time of the home-visit care of the user ‘b”’ At this time, the “movable distance” can be obtained as a value calculated by multiplying the spare time by the preset moving speed. The spare time is calculated by subtracting, from the start time for the user ‘b’, the end time obtained by adding the working time to the start time of another user previously visited by the carer ‘a’. Note that when the “moving distance from the location of the carer ‘a’ to the location of the user ‘b”’ and the “movable distance from the end time of the home-visit care of the previous user by the carer ‘a’ until the start time of the home-visit care of the user ‘b’”, obtained for calculating the score as described above, are respectively divided by the preset moving speed of the carer ‘a’, they represent the “moving time” and the “spare time” of the carer ‘a’ respectively. Therefore, the score s(a, b) becomes a value equivalent to the sum of the “moving time” and the “spare time”. Specifically, the score s(a, b) is calculated by Expression 1 provided below.

$$s ( a , b ) = \sqrt{\begin{matrix}{( x coorddinate of a - x coordinate of b )}^{2} + \\ {( y coorddinate of a - y coordinate of b )}^{2}\end{matrix}} + ( start time of b - end time before a ) \times moving speed \qquad [ Expression 1 ]$$

In the case of calculating the scores of the user 2 and the user 3 with respect to the carer A from Expression 1, since the carer A moves to the user 2 or the user 3 after the end of home-visit care of the user 1, the location and the end time of the carer A can be represented by the location and the end time of the user 1. Therefore, the scores of the user 2 and the user 3 with respect to the carer A are represented as s(user 1, user 2) and s(user 1, user 3) respectively, which take values calculated by Expressions 2 and 3 provided below. Note that the moving speed of the carer A is assumed to be 30 km/h, for example.

$$s ( 1 , 2 ) = \sqrt{{( 1 - 3 )}^{2} + {( 4 - 5 )}^{2}} [ km ] + \frac{45 [ min ]}{60 [ min ]} \times 30 [ km / h ] ≅ 25 \qquad [ Expression 2 ]$$

$$s ( 1 , 3 ) = \sqrt{{( 1 - 2 )}^{2} + {( 4 - 3 )}^{2}} [ km ] + \frac{90 [ min ]}{60 [ min ]} \times 30 [ km / h ] ≅ 46 \qquad [ Expression 3 ]$$

Then, the calculation unit 12 may handle the score such that the priority is higher as the value of the score is smaller, and set the score value as it is as the priority or further calculate the priority from the score. For example, among the scores of the users with respect to the same carer, the calculation unit 12 may obtain the order of the scores in the ascending order as the priority value. In that case, it is shown that as the numerical value is smaller, the priority is higher.

In the case of the above-described example, since the score of the user 2 is smaller than the score of the user 3, the priority of the user 2 is calculated to be higher than the priority of the user 3. Similarly, when the scores of the user 4 and the user 5 with respect to the carer B are calculated from Expression 1, since the score of the user 4 is smaller than the score of the user 5, the priority of the user 4 is calculated to be higher than the priority of the user 5.

Note that the calculation unit 12 is not necessarily limited to calculate the priority as described above. For example, the calculation unit 12 may calculate the priority of a user with respect to a carer on the basis of the attribute information representing the attributes of the carer and the user and the relevance information representing the relevance between the carer and the user that are stored as visit data. As an example, it is assumed that the attribute information is information such as qualification and the field of expertise of the carer and the condition of care of users that the carer can handle, and information such as the condition of care of the user. In that case, when the qualification and the field of expertise included in the attribute information of the carer and the condition of care that is the attribute information of the user have a correspondence relation set in advance, for example, when it is set that the condition of care of the user should be handled by a carer having a particular qualification or field of expertise, the calculation unit 12 may calculate the score, calculated as described above, by applying a weight so that the score becomes a smaller value. Further, it is also assumed that the relevance information is correspondence information between a carer and a user determined to be cared by the carer, correspondence information between the carer and a user cared by the carer in the past, correspondence information between the carer and a user who desires to be cared by the carer, or the like, as an example. In that case, when a user is associated with a carer, the calculation unit 12 may calculate the score, calculated as described above, by applying a weight so that the score becomes a smaller value. As a result, when a carer and a user are associated with each other in the attribute information or the relevance information, the score of the user is calculated to be smaller so that the priority becomes higher.

The reassignment unit 13 changes the assignment of the users 1 to 5 to the respective carers A and B on the basis of the priority calculated as described above to create a visit schedule again. Specifically, among the conflicted users with respect to each of the carers A and B, the reassignment unit 13 first assigns a user having the highest priority and rejects assignment of the other users to solve the conflict. For example, with respect to the carer A, as illustrated in the solid lines and the dotted lines in FIG. 3 (3-3), first, the user 1 remains assigned, and of the conflicted users 2 and 3, the user 2 having the higher priority is assigned and assignment of the user 3 having the lower priority is canceled. With respect to the carer B, as illustrated in the solid lines and the dotted lines in FIG. 3 (3-3), of the conflicted users 4 and 5, the user 4 having the higher priority is assigned and the assignment of the user 5 having the lower priority is canceled.

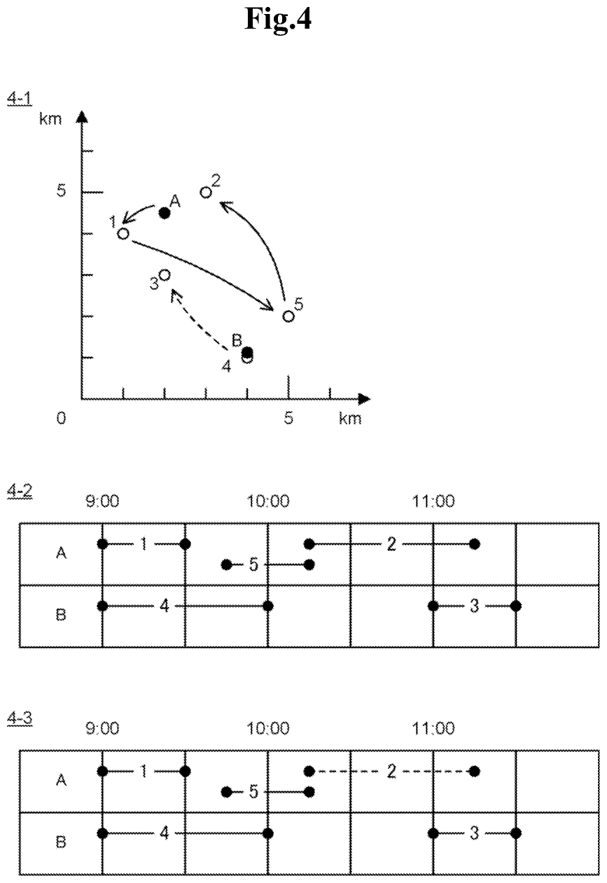

Then, the reassignment unit 13 keeps assignment of the users 1, 2, and 4 to the respective carers A and B, and reassigns the users 3 and 5 whose assignment to the carers were canceled, to the carers. At that time, the reassignment unit 13 first changes the initial areas of the respective carers A and B according to the locations of the users who remains assigned. For example, as illustrated in FIG. 4 (4-1), the reassignment unit 13 changes the initial area of the carer A to the intermediate location between the addresses of the users 1 and 2 who remains assigned, and changes the initial area of the carer B to the address of the user 4 who remains assigned. Then, the reassignment unit 13 calculates the distances to the addresses of the users 3 and 5 whose assignment was canceled with respect to the initial areas of the carers A and B, and reassign the users 3 and 5 to the carers A and B on the basis of such distances. At that time, the reassignment unit 13 may assign the users 3 and 5 whose assignment was canceled to carers who are different from the cares to whom they were assigned previously, regardless of the distances between the carers and the users. For example, in the example of FIG. 4 (4-1), the user 5 is assigned to the carer A anew and the user 3 is assigned to the carer B anew. In this way, as illustrated in FIG. 4 (4-2), the reassignment unit 13 reassigns the users 1, 5, and 2 to the carer A and reassigns the users 4 and 3 to the carer B. Note that FIG. 4 (4-2) illustrates a visit schedule in which the start time and the working time for each user are considered. In FIG. 4 (4-1), the solid line arrow indicates movement of the carer A and the dotted line arrow indicates movement of the carer B.

Here, the calculation unit 12 described above will be further explained. The calculation unit 12 also checks whether or not there is a conflict between the users assigned to a carer in the visit schedule created by the reassignment unit 13 as similar to the above-described case, and calculates priorities of the conflicted users. Specifically, in the case of the visit schedule in FIG. 4 (4-2), since the user 5 and the user 2 are assigned to the carer A at the same time, the calculation unit 12 determines that there is a conflict between the user 5 and the user 2, while determines that there is no conflict with respect to the carer B. Therefore, the calculation unit 12 calculates the priorities of the conflicted user 5 and user 2 with respect to the carer A. Note that the calculation unit 12 also checks whether or not there is a conflict between the users whose assignment is not canceled in the reassignment unit 13 again, and calculates the priorities of the conflicted users.

Then, as similar to the above-described case, the reassignment unit 13 changes the assignments of the users 1 to 5 to the respective carers A and B on the basis of the recalculated priorities to create a visit schedule again. Specifically, in the visit schedule in FIG. 4 (4-2), the reassignment unit 13 assigns the user 5 having a higher priority, of the conflicted users 5 and 2 with respect to the carer A, and cancels assignment of the user 2 having a lower priority, as illustrated in the solid lines and the dotted lines in FIG. 4 (4-3). Then, the reassignment unit 13 assigns the user 2 whose assignment is canceled to the other carer B. At that time, the reassignment unit 13 may change the initial area of the carer as described above and reassign the user based on the initial area.

As described above, the calculation unit 12 and the reassignment unit 13 repeat the above-described processing until there is no conflict between users assigned to all carers.

### [Operation]

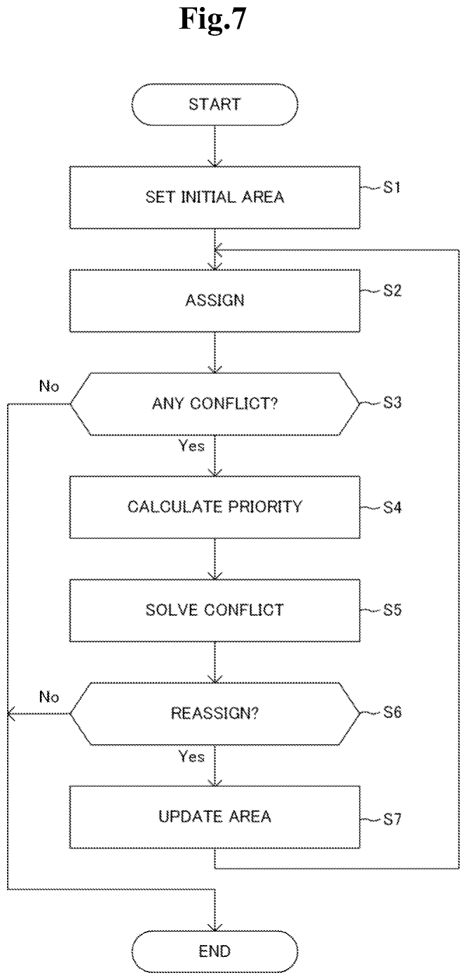

Next, operation of the visit schedule creation device 10 described above will be described with mainly reference to the location information and the visit schedules illustrated in FIGS. 2 to 6 and the flowchart of FIG. 7.

First, the visit schedule creation device 10 sets an initial area of each carer based on the visit data stored in the visit data storage unit 14 (step S1). For example, the visit schedule creation device 10 may use the initial area of each carer previously stored in the visit data as it is as illustrated in FIG. 2, or set the center of the addresses of a plurality of users as an initial area of a given carer.

Then, the visit schedule creation device 10 calculates a distance to the address of each user with respect to the initial area of each carer, and assigns each user to a carer whose distance is the shortest (step S2). For example, in the case of the visit data illustrated in FIG. 2, the visit schedule creation device 10 assigns the users 1 to 5 to either the carer A or the carer B whose distance is shorter. As a result, as illustrated in FIG. 3 (3-1), the visit schedule creation device assigns the users 1, 2, and 3 to the carer A, and assigns the users 4 and 5 to the carer B. Then, the visit schedule creation device 10 creates a visit schedule in which the start time and the working time for each user are set, as illustrated in FIG. 3 (3-2).

Then, the visit schedule creation device 10 checks whether or not there is a conflict between users assigned to a carer in the visit schedule created as described above (step S3). For example, the visit schedule creation device 10 determines that there is a conflict when a plurality of users are assigned to the same carer at the same time, that is, in the case where the working time from the start time of the respective users assigned to one carer overlap. For example, in the visit schedule illustrated in FIG. 3 (3-2), since the user 2 and the user 3 are assigned to the carer A at the same time, the visit schedule creation device 10 determines that there is a conflict between the user 2 and the user 3. Moreover, since the user 4 and the user 5 are assigned to the carer B at the same time, the visit schedule creation device 10 determines that there is a conflict between the user 4 and the user 5.

Then, when determining that there is a conflict between users with respect to the same carer, (Yes at step S3), the visit schedule creation device 10 calculates the priority representing the level of visiting priority with respect to each of the conflicted users assigned to the carer (step S4). At that time, the visit schedule creation device 10 calculates the priority in such a manner that the priority becomes higher as the sum of the moving time to visit the user by the carer and the spare time until the carer starts caring for the user become shorter. Note that the visit schedule creation device 10 may calculate the priority of a user associated with the carer to be higher by applying a weight, on the basis of the attribute information representing the attributes of the carer and the user and the relevance information representing the relevance between the carer and the user.

In the visit schedule illustrated in FIG. 3 (3-2), since the priority of the user 2 is higher than the priority of the user 3 with respect to the carer A, the visit schedule creation device 10 preferentially assigns the user 2 as shown by the solid line of FIG. 3 (3-3), and cancels the assignment of the user 3 as shown by the dotted line in FIG. 3 (3-3). With respect to the carer A, the user 1 who does not conflict remains assigned. Similarly, in the visit schedule illustrated in FIG. 3 (3-2), since the priority of the user 4 is higher than the priority of the user 5 with respect to the carer B, the visit schedule creation device 10 preferentially assigns the user 4 as shown by the solid line of FIG. 3 (3-3), and cancels the assignment of the user 5 as shown by the dotted line in FIG. 3 (3-3). In this way, the visit schedule creation device 10 solves the conflict between the users in the visit schedule (step S5).

Then, when there is a user who is not assigned because the assignment of the user was canceled as described above, the visit schedule creation device 10 keeps the assignment of the users 1, 2, and 4 assigned to the respective carers A and B, and reassigns the users 3 and 5 whose assignment to the carers was canceled to the carers (Yes at step S6). At that time, the visit schedule creation device 10 changes the initial areas of the respective carers A and B according to the locations of the users who remain assigned (step S7). For example, as illustrated in FIG. 4 (4-1), the visit schedule creation device 10 changes the initial area of the carer A to the intermediate location between the locations of the users 1 and 2 who remain assigned, and changes the initial area of the carer B to the location of the user 4 who remains assigned. Note that the initial area is not necessarily changed.

Then, the visit schedule creation device 10 calculates the distances to the addresses of the users 3 and 5 whose assignment was canceled with respect to the initial areas of the carers A and B, and reassigns the users 3 and 5 to the carers A and B based on such distances (step S2). At that time, the visit schedule creation device 10 may assign the users 3 and 5 whose assignment was canceled to carers who are different from the cares to whom they were assigned previously, regardless of the distances between the carers and the users. For example, in the example of FIG. 4 (4-1), the visit schedule creation device 10 assigns the user 5 to the carer A anew and assigns the user 3 to the carer B anew. In this way, as illustrated in FIG. 4 (4-2), the visit schedule creation device 10 creates a visit schedule in which the users 1, 5, and 2 are assigned to the carer A and the users 4 and 3 are assigned to the carer B.

Then, the visit schedule creation device 10 checks whether or not there is a conflict between the users assigned to a carer as similar to the above description, in the visit schedule recreated as described above (step S3). As an example, in the visit schedule shown in FIG. 4 (4-2), with respect to the carer A, the visit schedule creation device 10 determines that there is a conflict between the user 5 and the user 2 because the user 5 and the user 2 are assigned to the carer A at the same time.

Then, when determining that there is a conflict between users with respect to the same carer (Yes at step S3), the visit schedule creation device 10 calculates the priority representing the level of visiting priority with respect to each of the conflicted users assigned to the carer (step S4). Then, in the visit schedule illustrated in FIG. 4 (4-2), since the priority of the user 5 is higher than the priority of the user 2 with respect to the carer A, the visit schedule creation device 10 preferentially assigns the user 5 as shown by the solid line in FIG. 4 (4-3), and cancels the assignment of the user 2 as shown by the dotted line in FIG. 4 (4-3). In this way, the visit schedule creation device 10 solves the conflict between the users in the visit schedule (step S5).

Then, when there is a user who is not assigned because the assignment of the user was canceled as described above, the visit schedule creation device 10 reassigns the user 2, whose assignment to the carer was canceled, to a carer (Yes at step S6). At that time, the visit schedule creation device 10 may change the initial areas of the respective carers A and B according to the locations of the users who remain assigned (step S7), or may not change them.

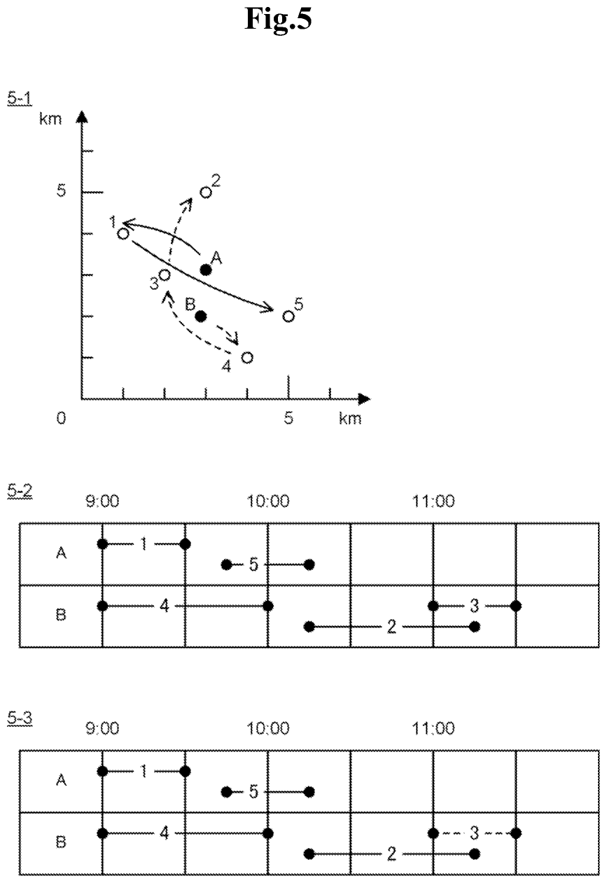

Then, the visit schedule creation device 10 reassigns the user 2 whose assignment was canceled as described above (step S2). In that case, the visit schedule creation device 10 may assign the user 2, whose assignment was canceled, to the carer B who is different from the carer to whom the user was assigned previously as illustrated in FIG. 5 (5-1). In this way, as illustrated in FIG. 5 (5-2), the visit schedule creation device 10 creates a visit schedule in which the users 1 and 5 are assigned to the carer A and the users 4, 2, and 3 are assigned to the carer B.

Then, the visit schedule creation device 10 checks whether or not there is a conflict between the users assigned to a carer as similar to the above description, in the visit schedule recreated as described above (step S3). As an example, in the visit schedule created as shown in FIG. 5 (5-2), the visit schedule creation device 10 determines that there is a conflict between the user 2 and the user 3 because the user 2 and the user 3 are assigned to the carer B at the same time.

Then, when determining that there is a conflict between the users with respect to the same carer (Yes at step S3), the visit schedule creation device 10 calculates the priority representing the level of visiting priority with respect to each of the conflicted users assigned to the carer (step S4). Then, in the visit schedule illustrated in FIG. 5 (5-2), since the priority of the user 2 is higher than the priority of the user 3 with respect to the carer B, the visit schedule creation device 10 preferentially assigns the user 2 as shown by the solid line in FIG. 5 (5-3), and cancels the assignment of the user 3 as shown by the dotted line in FIG. 5 (5-3). In this way, the visit schedule creation device 10 solves the conflict between the users in the visit schedule (step S5).

Then, when there is a user who is not assigned because the assignment of the user was canceled as described above, the visit schedule creation device 10 reassigns the user 3, whose assignment to the carer was canceled, to a carer (Yes at step S6). At that time, the visit schedule creation device 10 may change the initial areas of the respective carers A and B according to the locations of the users who remain assigned (step S7), or may not change them.

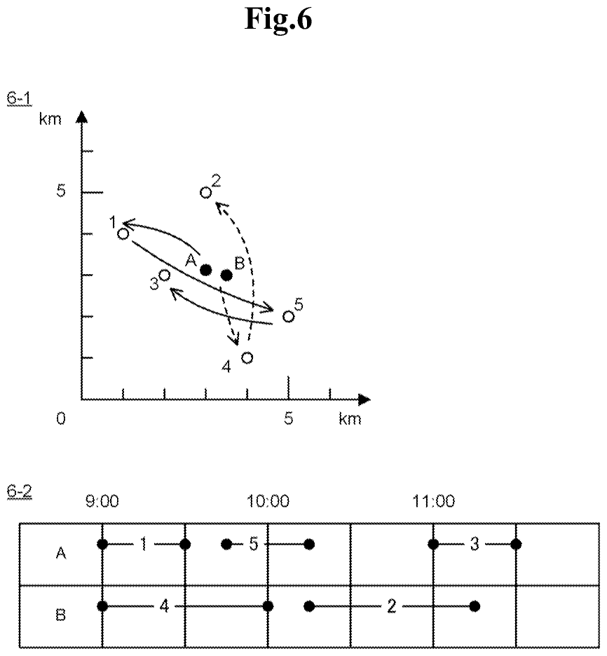

Then, the visit schedule creation device 10 reassigns the user 3 whose assignment was canceled as described above (step S2). In that case, the visit schedule creation device 10 may assign the user 3, whose assignment was canceled, to the carer A who is different from the carer B to whom the user was assigned previously as illustrated in FIG. 6 (6-1). In this way, as illustrated in FIG. 6 (6-2), the visit schedule creation device 10 creates a visit schedule in which the users 1, 5, and 3 are assigned to the carer A and the users 4 and 2 are assigned to the carer B. Then, in the created visit schedule, all user are assigned to all carers and conflict between the users is solved (No at step S3). Therefore, the visit schedule creation device 10 ends creation of a visit schedule.

As described above, in the present embodiment, the visit schedule creation device 10 first creates a visit schedule by collectively assigning all users to any carers by using location information of the carers who are visitors and the users who are visited persons. Then, when a conflict occurs, that is, when there are a plurality of users assigned to the same carer at the same time, the visit schedule creation device 10 calculates the priorities of the conflicted users, and creates a visit schedule in which the users are reassigned based on the priorities. As described above, since the visit schedule creation device 10 first collectively assigns all users and calculates priorities for only the conflicted users to perform reassignment, the calculation cost can be reduced. That is, since the visit schedule creation device 10 can create a visit schedule by a small resource computer, it is possible to reduce the cost for system introduction.

Thereafter, the visit schedule creation device 10 may output the created visit schedule so as to notify the operator of the service provider, the carers A and B, and the users 1 to 5 to be cared and their families. For example, the visit schedule creation device 10 may transmit information of the visit schedule as illustrated in FIG. 6 (6-2) to the addresses of the information processing terminals (smartphones, tablet terminals, personal computers, and the like) that are registered in advance and operated by the operator of the service provider, the carers A and B, and the users 1 to 5 to be cared and their families. At that time, the content of the visit schedule to be transmitted may include, for the operator of the service provider, the schedule of all cares, for each of the carers A and B, own schedule only, and for the users 1 to 5 and their families, own schedule only (visiting carer and the time). As a result, in particular, the operator, the carers A and B, and the users 1 to 5 and their families can confirm the own caring schedule by displaying the visit schedule on the display device of each information processing terminal.

Thereafter, information indicating a request for changing the visit schedule may be notified from the carers A and B or the users 1 to 5 to the business operator. In that case, the visit schedule creation device 10 receives change request information transmitted from the information processing terminals of the carers A and B and the users 1 to 5, and transmits such information to the information processing terminal of the operator and displays it on the display device to thereby notify the operator. Then, the visit schedule creation device 10 may perform processing to further change the visit schedule according to the operation by the operator based on the change request information, and output the changed visit schedule to the carers A and B, the users 1 to 5, and the like. Note that the visit schedule creation device 10 may perform processing to change the visit schedule automatically according to the change request information, rather than operation by the operator. For example, the visit schedule creation device 10 may assign a user, giving a change request, to another carer from the carer before the change, and assign the remaining users to the respective carers as described above, and then solve the conflict as described above to create a final visit schedule.

### Second Exemplary Embodiment

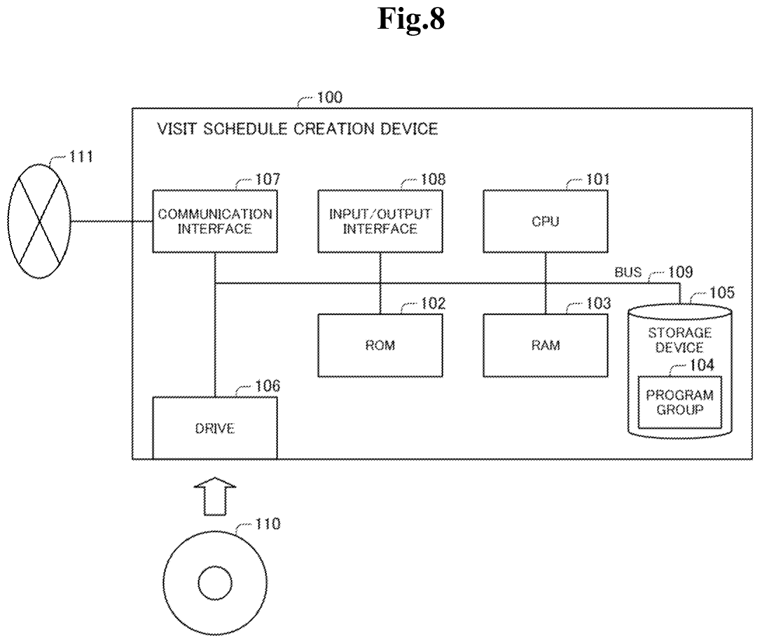

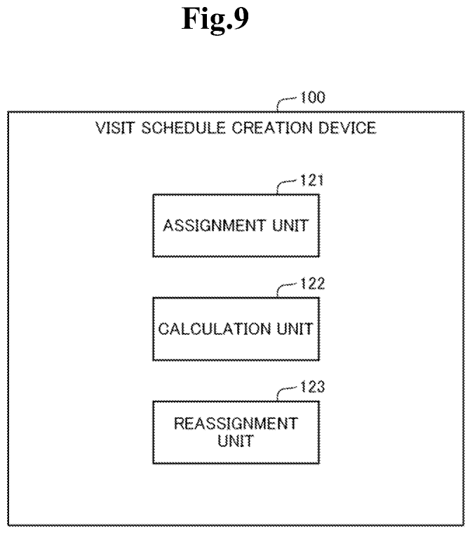

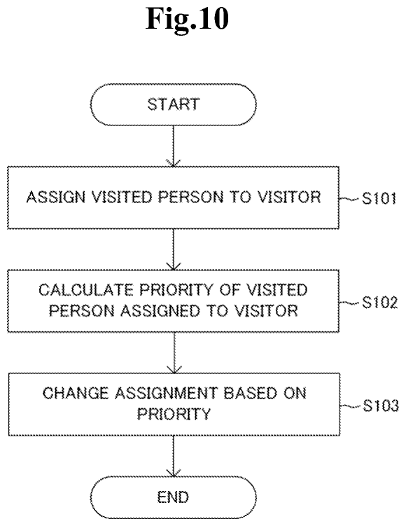

Next, a second exemplary embodiment of the present invention will be described with reference to FIGS. 8 to 10. FIGS. 8 and 9 are block diagrams illustrating a configuration of a visit schedule creation device according to the second exemplary embodiment, and FIG. 10 is a flowchart illustrating an operation of the visit schedule creation device. Note that the present embodiment shows the outlines of the configurations of the visit schedule creation device and the visit schedule creation method described in the embodiment described above.

First, a hardware configuration of the visit schedule creation device 100 in the present embodiment will be described with reference to FIG. 8. The visit schedule creation device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

The visit schedule creation device 100 can construct, and can be equipped with, an assignment unit 121, a calculation unit 122, and a reassignment unit 123 illustrated in FIG. 9 through acquisition and execution of the program group 104 by the CPU 101. Note that the program group 104 and visit data that is data used for creating a visit schedule are stored in the storage device 105 or the ROM 102 in advance, and are loaded to the RAM 103 and executed by the CPU 101 as needed. Further, the program group 104 and the visit data may be provided to the CPU 101 via the communication network 111, or may be stored on the storage medium 110 in advance and read out by the drive 106 and supplied to the CPU 101. Further, regarding the visit data, only part of the stored data may be supplied over the communication network 111 and corrected. However, the assignment unit 121, the calculation unit 122, and the reassignment unit 123 may be constructed by dedicated electronic circuits for implementing such means.

Note that FIG. 8 illustrates an example of a hardware configuration of an information processing device that is the visit schedule creation device 100. The hardware configuration of the information processing device is not limited to that described above. For example, the information processing device may be configured of part of the configuration described above, such as without the drive 106.

The visit schedule creation device 100 executes the visit schedule creation method illustrated in the flowchart of FIG. 10, by the functions of the assignment unit 121, the calculation unit 122, and the reassignment unit 123 constructed by the program as described above.

As illustrated in FIG. 10, a visit schedule creation device 100 executes processing to
on the basis of location information of a visitor and a visited person, create a visit schedule in which the visited person, to be visited by the visitor, is assigned to the visitor (step S101),
on the basis of the location information, calculate a priority representing the level of priority of the visited person assigned to the visitor (step S102), and
on the basis of the priority, create the visit schedule in which assignment of the visited person to the visitor is changed (step S103).

With the configuration described above, the visit schedule creation device 100 first creates a visit schedule by collectively assigning all visited persons to any visitors by using location information of the visitors and the visited persons. Then, the visit schedule creation device 100 calculates the priorities of the visited persons assigned to the visitors, and creates a visit schedule in which the visited persons are reassigned based on the priorities. As described above, since the visit schedule creation device 100 once assigns the visited persons collectively and then calculates the priorities of the visited persons to perform reassignment, the calculation cost can be reduced. That is, since the visit schedule creation device 100 can be handled by a small resource computer, it is possible to reduce the cost for system introduction.

Note that the program described above can be supplied to a computer by being stored in a non-transitory computer readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), flash ROM, and RAM (Random Access Memory)). The program may be supplied to a computer by a transitory computer-readable medium of any type. Examples of transitory computer-readable media include electric signals, optical signals, and electromagnetic waves. A transitory computer readable medium can supply a program to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the assignment unit 121, the calculation unit 122, and the reassignment unit 123 described above may be carried out by an information processing device provided and connected to any location on the network, that is, may be carried out by so-called cloud computing.

### <Supplementary Notes>

The whole or part of the exemplary embodiments disclosed above can be described as the following supplementary notes. Hereinafter, outlines of the configurations of a visit schedule creation method, a visit schedule creation device, and a program according to the present invention will be described. However, the present invention is not limited to the configurations described below.

### (Supplementary Note 1)

A visit schedule creation method comprising:
on a basis of location information of a visitor and a visited person, creating a visit schedule in which the visited person, to be visited by the visitor, is assigned to the visitor;
calculating priority representing a level of priority of the visited person assigned to the visitor, on the basis of the location information; and
creating the visit schedule in which assignment of the visited person to the visitor is changed, on a basis of the priority.

### (Supplementary Note 2)

The visit schedule creation method according to supplementary note 1, further comprising
when a plurality of the visited persons are assigned to a same visitor at a same time in the created visit schedule, calculating the priority of the visited persons assigned at the same time.

### (Supplementary Note 3)

The visit schedule creation method according to supplementary note 1 or 2, further comprising
calculating a moving distance between the visited persons by the visitor on the basis of the location information, and calculating the priority on a basis of the moving distance.

### (Supplementary Note 4)

The visit schedule creation method according to supplementary note 3, further comprising
calculating the priority on a basis of the moving distance and a scheduled visit time representing a predetermined scheduled time of visiting the visited person.

### (Supplementary Note 5)

The visit schedule creation method according to supplementary note 4, further comprising
calculating the priority on a basis of the moving distance, the scheduled visit time, and a scheduled staying time representing a predetermined staying time when the visited person is visited.

### (Supplementary Note 6)

The visit schedule creation method according to supplementary note 5, further comprising
calculating a spare time until the visitor visits a next visited person on the basis of the scheduled visit time and the scheduled staying time, and calculating the priority on a basis of the moving distance and the spare time.

### (Supplementary Note 7)

The visit schedule creation method according to any of supplementary notes 1 to 6, further comprising
calculating the priority of the visited person assigned to the visitor, on a basis of attribute information representing attributes of the visitor and the visited person.

### (Supplementary Note 8)

The visit schedule creation method according to any of supplementary notes 1 to 7, further comprising
calculating the priority of the visited person assigned to the visitor, on a basis of relevance information representing relevance between the visitor and the visited person.

### (Supplementary Note 9)

The visit schedule creation method according to any of supplementary notes 1 to 8, further comprising
creating the visit schedule in which the visited person is assigned to the visitor, on a basis of an initial value of the location information of the visitor and the location information of the visited person; and
when creating the visit schedule based on the priority, changing the location information of the visitor according to the location information of the visited person specified based on the priority, and creating the visit schedule in which the assignment of the visited person to the visitor is changed based on the changed location information.

### (Supplementary Note 10)

A visit schedule creation device comprising:
an assignment unit that, on a basis of location information of a visitor and a visited person, creates a visit schedule in which the visited person, to be visited by the visitor, is assigned to the visitor;
a calculation unit that calculates priority representing a level of priority of the visited person assigned to the visitor, on the basis of the location information; and
a reassignment unit that creates the visit schedule in which assignment of the visited person to the visitor is changed, on a basis of the priority.

### (Supplementary Note 11)

The visit schedule creation device according to supplementary note 10, wherein
when a plurality of the visited persons are assigned to a same visitor at a same time in the created visit schedule, the calculation unit calculates the priority of the visited persons assigned at the same time.

### (Supplementary Note 12)

The visit schedule creation device according to supplementary note 10 or 11, wherein
the calculation unit calculates a moving distance between the visited persons by the visitor on the basis of the location information, and calculates the priority on a basis of the moving distance.

### (Supplementary Note 13)

The visit schedule creation device according to supplementary note 12, wherein
the calculation unit calculates the priority on a basis of the moving distance and a scheduled visit time representing a predetermined scheduled time of visiting the visited person.

### (Supplementary Note 14)

The visit schedule creation device according to supplementary note 13, wherein
the calculation unit calculates the priority on a basis of the moving distance, the scheduled visit time, and a scheduled staying time representing a predetermined staying time when the visited person is visited.

### (Supplementary Note 15)

The visit schedule creation device according to supplementary note 14, wherein
the calculation unit calculates a spare time until the visitor visits a next visited person on the basis of the scheduled visit time and the scheduled staying time, and calculates the priority on a basis of the moving distance and the spare time.

### (Supplementary Note 16)

The visit schedule creation device according to any of supplementary notes 10 to 15, wherein
the calculation unit calculates the priority of the visited person assigned to the visitor, on a basis of attribute information representing attributes of the visitor and the visited person.

### (Supplementary Note 17)

The visit schedule creation device according to any of supplementary notes 10 to 16, wherein
the calculation unit calculates the priority of the visited person assigned to the visitor, on a basis of relevance information representing relevance between the visitor and the visited person.

### (Supplementary Note 18)

The visit schedule creation device according to any of supplementary notes 10 to 17, wherein
the assignment unit creates the visit schedule in which the visited person is assigned to the visitor, on a basis of an initial value of the location information of the visitor and the location information of the visited person; and
when the reassignment unit creates the visit schedule based on the priority, the reassignment unit changes the location information of the visitor according to the location information of the visited person specified based on the priority, and creates the visit schedule in which the assignment of the visited person to the visitor is changed based on the changed location information.

### (Supplementary Note 19)

A computer-readable medium storing thereon a program for causing a computer to execute processing to:
on a basis of location information of a visitor and a visited person, create a visit schedule in which the visited person, to be visited by the visitor, is assigned to the visitor;
calculate priority representing a level of priority of the visited person assigned to the visitor, on the basis of the location information; and
create the visit schedule in which assignment of the visited person to the visitor is changed, on a basis of the priority.

### REFERENCE SIGNS LIST

10 visit schedule creation device
11 assignment unit
12 calculation unit
13 reassignment unit
14 visit data storage unit
100 visit schedule creation device
101 CPU
102 ROM
103 ROM
104 program group
105 storage device
106 drive
107 communication interface
108 input/output interface
109 bus
110 storage medium
111 communication network
121 assignment unit
122 calculation unit
123 reassignment unit

What is claimed is:

1. A method for a device to create a visit schedule in communication with a client terminal, the method comprising:
on a basis of location information of a visitor and a visited person, creating a visit schedule in which the visited person, to be visited by the visitor, is assigned to the visitor;
calculating priority representing a level of priority of the visited person assigned to the visitor, on the basis of the location information;
creating the visit schedule in which assignment of the visited person to the visitor is changed, on a basis of the priority; and
transmitting the visit schedule to the client terminal owned by at least one of the visitor and the visited person.

2. The method according to claim 1, further comprising
when a plurality of the visited persons are assigned to a same visitor at a same time in the created visit schedule, calculating the priority of the visited persons assigned at the same time.

3. The method according to claim 1, further comprising
calculating a moving distance between the visited persons by the visitor on the basis of the location information, and calculating the priority on a basis of the moving distance.

4. The method according to claim 3, further comprising
calculating the priority on a basis of the moving distance and a scheduled visit time representing a predetermined scheduled time of visiting the visited person.

5. The method according to claim 4, further comprising
calculating the priority on a basis of the moving distance, the scheduled visit time, and a scheduled staying time representing a predetermined staying time when the visited person is visited.

6. The method according to claim 5, further comprising
calculating a spare time until the visitor visits a next visited person on the basis of the scheduled visit time and the scheduled staying time, and calculating the priority on a basis of the moving distance and the spare time.

7. The method according to claim 1, further comprising
calculating the priority of the visited person assigned to the visitor, on a basis of attribute information representing attributes of the visitor and the visited person.

8. The method according to claim 1, further comprising
calculating the priority of the visited person assigned to the visitor, on a basis of relevance information representing relevance between the visitor and the visited person.

9. The method according to claim 1, further comprising
creating the visit schedule in which the visited person is assigned to the visitor, on a basis of an initial value of the location information of the visitor and the location information of the visited person; and
when creating the visit schedule based on the priority, changing the location information of the visitor according to the location information of the visited person specified based on the priority, and creating the visit schedule in which the assignment of the visited person to the visitor is changed based on the changed location information.

10. A visit schedule creation device comprising:
at least one memory configured to store instructions; and
at least one processor configured to execute instructions to:
on a basis of location information of a visitor and a visited person, create a visit schedule in which the visited person, to be visited by the visitor, is assigned to the visitor;
calculate priority representing a level of priority of the visited person assigned to the visitor, on the basis of the location information; and
create the visit schedule in which assignment of the visited person to the visitor is changed, on a basis of the priority.

11. The visit schedule creation device according to claim 10, wherein the at least one processor is configured to execute the instructions to,
when a plurality of the visited persons are assigned to a same visitor at a same time in the created visit schedule, calculate the priority of the visited persons assigned at the same time.

12. The visit schedule creation device according to claim 10, wherein the at least one processor is configured to execute the instructions to
calculate a moving distance between the visited persons by the visitor on the basis of the location information, and calculate the priority on a basis of the moving distance.

13. The visit schedule creation device according to claim 12, wherein the at least one processor is configured to execute the instructions to
calculate the priority on a basis of the moving distance and a scheduled visit time representing a predetermined scheduled time of visiting the visited person.

14. The visit schedule creation device according to claim 13, wherein the at least one processor is configured to execute the instructions to
calculate the priority on a basis of the moving distance, the scheduled visit time, and a scheduled staying time representing a predetermined staying time when the visited person is visited.

15. The visit schedule creation device according to claim 14, wherein the at least one processor is configured to execute the instructions to
calculate a spare time until the visitor visits a next visited person on the basis of the scheduled visit time and the scheduled staying time, and calculate the priority on a basis of the moving distance and the spare time.

16. The visit schedule creation device according to claim 10, wherein the at least one processor is configured to execute the instructions to
calculate the priority of the visited person assigned to the visitor, on a basis of attribute information representing attributes of the visitor and the visited person.

17. The visit schedule creation device according to claim 10, wherein the at least one processor is configured to execute the instructions to
calculate the priority of the visited person assigned to the visitor, on a basis of relevance information representing relevance between the visitor and the visited person.

18. The visit schedule creation device according claim 10, wherein the at least one processor is configured to execute the instructions to:
create the visit schedule in which the visited person is assigned to the visitor, on a basis of an initial value of the location information of the visitor and the location information of the visited person; and
when creating the visit schedule based on the priority, change the location information of the visitor according to the location information of the visited person specified based on the priority, and create the visit schedule in which the assignment of the visited person to the visitor is changed based on the changed location information.

19. A non-transitory computer-readable medium storing thereon a program comprising instructions for causing a computer to execute processing to:
on a basis of location information of a visitor and a visited person, create a visit schedule in which the visited person, to be visited by the visitor, is assigned to the visitor;
calculate priority representing a level of priority of the visited person assigned to the visitor, on the basis of the location information; and
create the visit schedule in which assignment of the visited person to the visitor is changed, on a basis of the priority.

20. The method according to claim 1, further comprising
receiving change request information for the visit schedule, the change request information being transmitted from the client terminal.
